(19) United States
(12) Patent Application Publication
(10) Pub. No.: US 2002/0146181 A1
(43) Pub. Date: Oct. 10, 2002

(54) System, method and computer program product for a multi-lingual text engine

(76) Inventors: Syed Aamer Azam, Union City, CA (US); Blair David Fraser, Berkeley, CA (US)

Correspondence Address: SILICON VALLEY INTELLECTUAL PROPERTY GROUP, P.O. BOX 721120, SAN JOSE, CA, 95172-1120, US

(21) Appl. No.: 09/778,391

(22) Filed: Feb. 6, 2001

(51) Int. Cl. G06K 9/03

(52) U.S. Cl. 382/309

(57) ABSTRACT

A system, method and computer program product are provided for multi-lingual text editing on any one of a plurality of devices. Initially, a device is identified. Thereafter, a text editing application is programmed for the device using the present invention as the core of the editor. Such programming includes implementing a user interface in accordance with the identified device, and writing a very small amount of additional code for the specific device. Next, the text editing application is loaded with data to support a plurality of languages. As such, during use, the text editing application may select languages that are to be used with edited documents.

### FIELD OF THE INVENTION

The present invention relates to text editors, and more particularly to text editor applications adapted for execution on thin client devices.

### BACKGROUND OF THE INVENTION

Today's word processing software enables even inexperienced users to prepare sophisticated documents. Word processors typically include a number of features that allow the user to format a document by defining the style, layout, or character font(s) of a document. Using these features, the user can create a variety of documents such as reports, letters, memos, etc. having different layouts, fonts, styles, etc.

Any word-processor should include the features of: a “cursor”, to enable any part of the text stored in a memory to be displayed; and “editing”, to enable the insertion, deletion or correction of text.

Recently, there has been a trend of creating portable computers capable of such word processing functions. Such portable computers conventionally have less computing power, storage area, etc. due to their smaller sizes. Examples of such portable computers include personal digital assistants (PDA's), palm computers, cellular phones, etc. As a result of the foregoing trend, there is a growing need to provide the traditional capabilities of word processors with minimal use of the resources of portable computers. One example of a product produced in response to this trend includes MICROSOFT® POCKETWORD®.

This reduction in resource requirements is of particular importance when dealing with word processors that are capable of handling multiple languages due to the associated increase in formatting and linguistic rules.

### DISCLOSURE OF THE INVENTION

A system, method and computer program product are provided for multi-lingual text editing on any one of a plurality of devices. Initially, a device is identified. Thereafter, a text editing application is programmed for the device using the present invention as the core of the editor. Such programming includes implementing a user interface in accordance with the identified device, and writing a very small amount of additional code for the specific device. The present invention provides all the nessasary application of language specific rules to the characters typed. Next, the text editing application is loaded with data to support a plurality of languages. As such, during use, the text editing application may select languages that are to be used with edited documents.

### BRIEF DESCRIPTION OF THE DRAWINGS

FIG. 1 shows a representative hardware environment in which the present invention may be carried out;

FIG. 2 shows another illustrative hardware environment in the form of a personal digital assistant, in accordance with one embodiment of the present invention;

FIG. 3 shows still another illustrative hardware environment in the form of a cellular phone, in accordance with one embodiment of the present invention;

FIG. 4 shows still yet another illustrative hardware environment in the form of a palm computer, in accordance with one embodiment of the present invention;

FIG. 5 illustrates a method for multi-lingual text editing on a device; and

FIG. 6 illustrates the various classes associated with the text editing application of the present invention.

### DESCRIPTION OF THE PREFERRED EMBODIMENTS

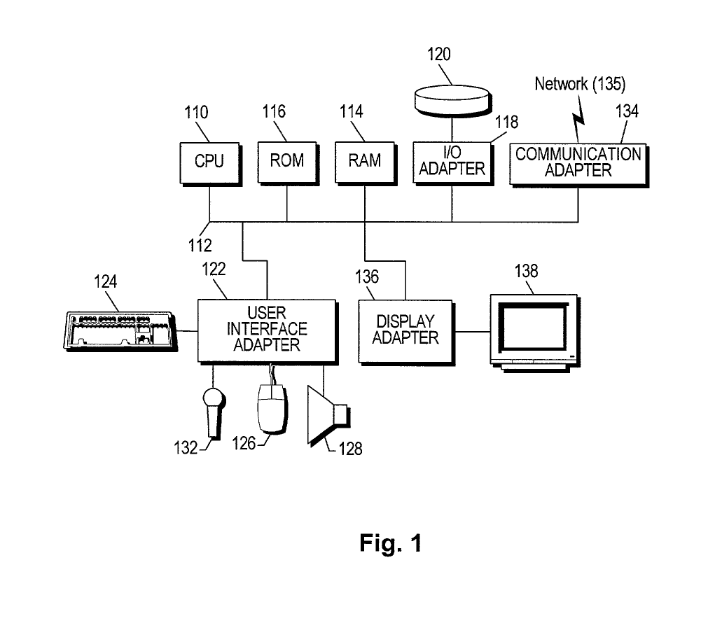

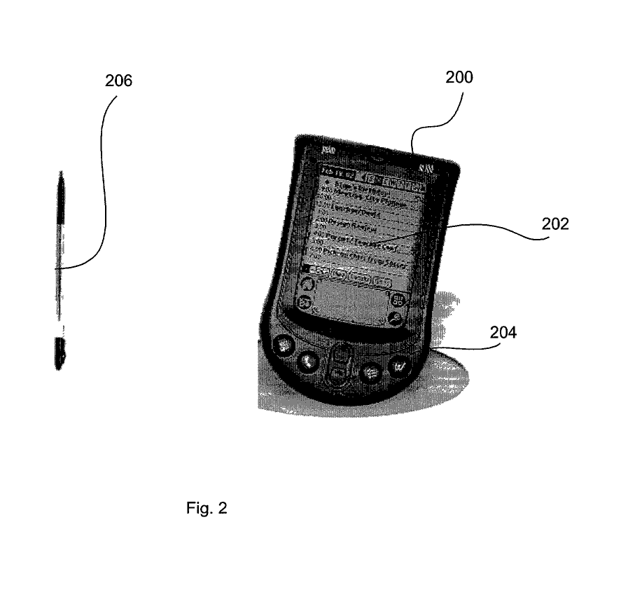

FIG. 1 shows a representative hardware environment that the present invention may support. Such figure illustrates a typical hardware configuration of a thin client device in accordance with a preferred embodiment having a central processing unit 110, such as a microprocessor, and a number of other units interconnected via a system bus 112. The thin client device shown in FIG. 1 includes a Random Access Memory (RAM) 114, Read Only Memory (ROM) 116, an I/O adapter 118 for connecting peripheral devices such as disk storage units 120 to the bus 112, a user interface adapter 122 for connecting a keyboard 124, a mouse 126, a speaker 128, a microphone 132, and/or other user interface devices such as a touch screen (not shown) to the bus 112, communication adapter 134 for connecting the thin client device to a communication network 135 (e.g., a data processing network) and a display adapter 136 for connecting the bus 112 to a display device 138. It should be noted that any of the foregoing components may be excluded in favor of enhancing the portability of the present invention. Specific examples of the foregoing thin client device are set forth in FIGS. 2 through 4.

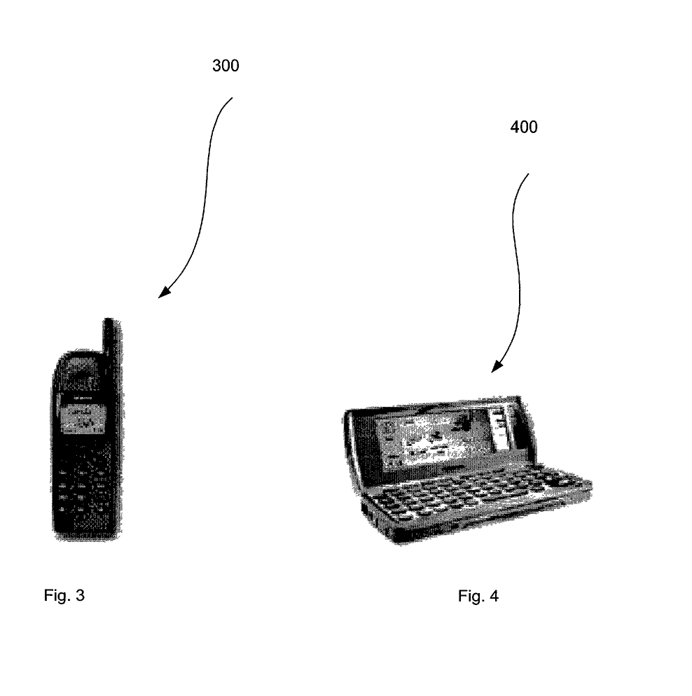

FIG. 2 shows another illustrative hardware environment in the form of a personal digital assistant 200, in accordance with one embodiment of the present invention. Such device 200 is preferably constructed with a plastic case housing, an LCD display panel 202, a keypad 204, and a stylus 206. FIG. 3 shows still another illustrative hardware environment in the form of a cellular phone 300, in accordance with one embodiment of the present invention. FIG. 4 shows still yet another illustrative hardware environment in the form of a palm computer 400, in accordance with one embodiment of the present invention.

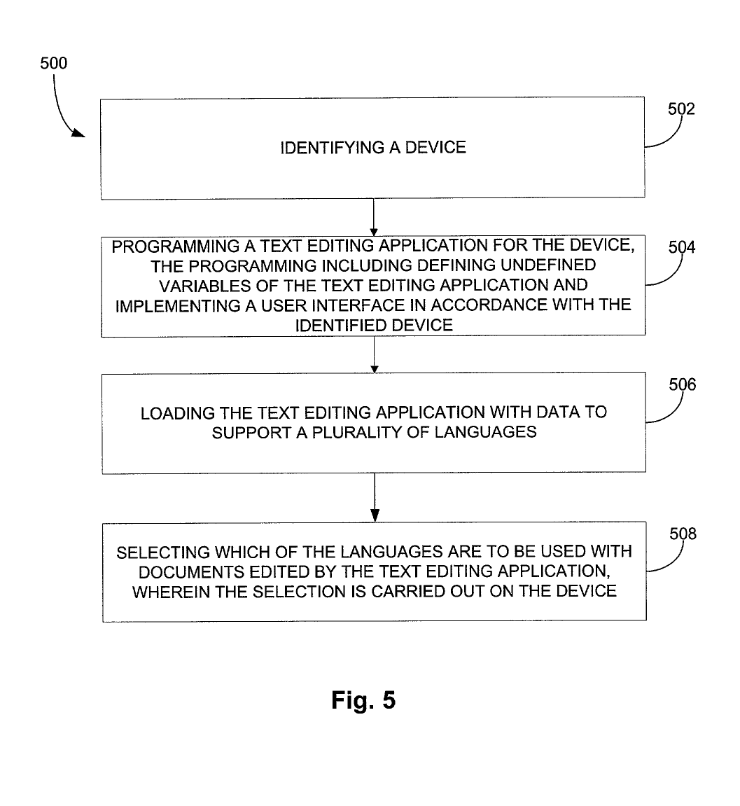

FIG. 5 illustrates a method 500 for multi-lingual text editing on any one of a plurality of devices. In one embodiment of the present invention, the device includes a personal digital assistant (PDA), a palm computer, a cellular phone, desktop computer, or any device that has a C/C++ compiler, a screen, and a method of controlling individuals pixels on the screen.

Initially, in operation 502, a device is identified. Thereafter, in operation 504, a text editing application is programmed for the device using the present invention as the core of the new program. In the context of the present description, “text editing application” may refer to any computer code capable of performing, supporting and/or facilitating text editing function(s) and providing a user interface, while “engine” is the central core of the “text editing application” without a user interface. The engine includes a list of supported languages, which are loaded onto the device with which the user may create documents.

The programming of operation 504 includes defining some platform dependent variables and methods of the engine and implementing a user interface in accordance with the identified device. More information regarding such step will be set forth later in greater detail.

Next, in operation 506, the engine is loaded with data to support a plurality of languages. As such, during use, the user may select languages that are to be used with edited documents. See operation 508.

Thus the present invention may be used to facilitate multilingual text editing on virtually any computing platform, especially on small, low memory, slow thin client portable devices. The various features that will now be set forth are designed with a purpose of minimizing the size and maximizing the speed and portability of the engine.

In essence, the present invention facilitates the core components relating to composition of documents in one of the many supported world languages, or any combination of those languages. The engine alone is not necessarily a full text editor. Instead, it is used to create a text editor or any other program that aims to provide multi-lingual support to the user. The present invention performs most, if not all, of the tasks that come with creating a text editor, i.e. line breaking, calculating screen character placement, text navigation, document storage in memory, etc. One “variable” that the present invention may optionally leave to the user's discretion is the specific design of a graphical interface that is capable of working for a specific platform.

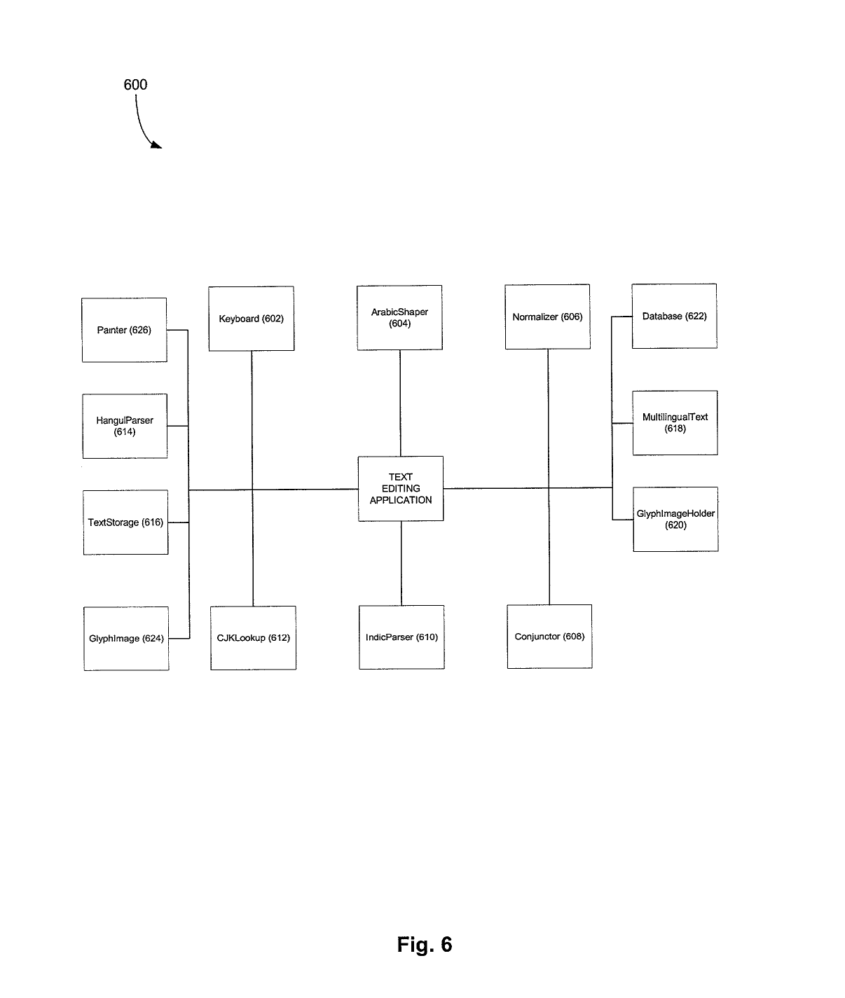

Languages that require special contextualization are also be supported by the engine; all contextualization is done within the engine. A full description of the engine's capabilities is set forth in greater detail in Table 1 and the description coinciding with FIG. 6.

TABLE 1

Mapping of ASCII values on English US keyboard to characters on a
foreign languages keyboard.
Providing the images of characters that would appear on a foreign
language keyboard.
Buffering of text for copying, cutting and pasting text.
Providing instructions indicating which characters are selected
for text selection with a cursor. (Note: When left-to-right and right-
to-left languages are combined, the selected characters are determined
by literary order, not visual order.)
Storage of document text in memory.
Storage of bitmap data and native image type data for each
character supported.
Text navigation and cursor movement and calculation of cursor
placement.
Setting the font and the font height, and scaling the images
accordingly.
Calculating what parts of the text need to be repainted when that
information is available to the engine. (Note: At times such as a
window expose, this information is not available to the engine, and
must be provided by the platform code.)
Alternative character input for languages such as Chinese, Japanese
and Korean.
Calculation of character placement on screen in both left-to-right
and right-to-left languages, as well as combinations thereof. (Note:
This can be very complicated when left-to-right and right-to-left
languages are combined.)

| | |
|---|---|
| - | Contextualization of Indic, South Asian, and |
| | Middle Eastern, and other languages. |
| - | Re-ordering of characters in Indic and other languages. |

Composition of accented or special characters.
Execution of rules that must be followed in the composition of text
in many other languages.
Tracking and calculating aspects of the text, such as length, line
breaks, line widths and heights.
Storage and decompression of the font data. (Note: A platform that
only supports English can thus be made to support every language
that the loaded engine supports.)

Support for several languages that are written in a right-to-left fashion is also provided. As mixing these languages with left-to-right languages can make the placing of characters on the screen in the linguistically correct order very difficult, the engine handles this calculation in every language, or multi-language combination, that may appear in a document.

As such, the engine handles all major issues in composing a document in any one language, or a combination of languages, including the calculation of character placement on the screen. The engine itself works with a virtual screen without actually painting the characters to the screen, as painting to the screen is without exception a platform-dependent operation. As mentioned earlier, one “variable” that the present invention may optionally leave to the user's discretion is the specific design of a graphical interface that is capable of working for a specific platform.

The class interface to the engine is created using a plurality of methods such as pressKey, getCharImage, moveCursorRight, and many more to be described hereinafter. Such functions make the creation of a simple text editor possible. Together, these methods can be combined to create a complicated and powerful program that supports a large percentage of the world's languages.

In addition, the present invention is designed to ensure that the list of supported languages can be easily changed. If support for a small number of local languages is required, the engine can be compiled with only the data necessary for those languages, thus saving memory space. This same fluidity allows new languages to be added very quickly if those languages contain no special rules, or special rules of the type already supported. The addition of languages that have entirely new rules can also be accomplished with little additional effort.

In order that the engine work on any computing platform, including thin client devices such as cell phones and PDA'S, the engine of the present invention allows the final platform programmer to make some simple changes to specific components thereof. In other words, the engine allows itself to be compiled and optimized for a specifically intended platform with only a few simple changes.

One of these methods allows all variables to be defined by the platform programmer; C/C++ types such as “int” and “char” are not used in the engine. In their place, undefined types are used. The platform programmer may thus define these types in a file, Types.h, before compiling the engine. When the platform programmer defines these types properly, the engine can be certain of the sizes of each type. For example, the engine of the present invention assumes that an Int is 4 bytes long. On an EPOC platform, Int can be defined as set forth in Table 2.

TABLE 2
#define Int Tint, where Tint is a 4 byte signed integer on the EPOC
platform.

Another method to facilitate platform independence includes allowing a platform-dependent image type to be included alongside a platform-independent image type at runtime. This feature allows the platform programmer to convert highly compressed images to a fast platform native image type that is optimized for speed as they are needed. A number of these images are then stored within the engine to allow for a very effective optimization that can be written for any platform. This optimization will be discussed hereinafter in greater detail.

The engine has been written in a subset of C++ that has been found to be supported on most, if not all, platforms. FIG. 6 illustrates the various classes 600 associated with the text editing application of the present invention.

Keyboard (602)

A keyboard class is responsible for converting ASCII values on the English US keyboard into Unicode values that appear on other keyboards. When selecting a language from the engine, each character in that language's alphabet is assigned to a key on the English US keyboard. The keyboard class is responsible for converting the ASCII key typed to the Unicode value that is inserted into the text. In this manner, the platform programmer does not need to know the language with which the end user might be composing.

One interesting aspect of the Keyboard class is that a single instance can represent every language's keyboard simply by loading in different keyboard data from a database.

ArabicShaper (604)

An ArabicShaper class is responsible for the contextualization of Arabic, Urdu and Farsi. Many characters in these languages have several forms. The correct form of any given character is determined by the characters surrounding it. As each of the forms has a separate Unicode value, the ArabicShaper class is responsible for converting the Unicode that was received from the virtual keyboard to the final Unicode representing the character in the proper form. This is done utilizing a lookup table, derived from the Unicode standard. The full algorithm is also defined in the Unicode standard. The ArabicShaper class is capable of working on Arabic text in both ways, converting the initial form to the final form, based on the surrounding text, or undoing this operation. The reverse operation is important to convert the Arabic text back to the original forms, which are more suitable for transmission to another editor or stored to disk.

Normalizer (606)

The Normalizer class is responsible for combining two Unicode values into a single Unicode value, as the selected language's rules require. For example, the Spanish letter ñ is composed of a ‘n’ key press followed by a ‘˜’ key press. The Normalizer class converts n˜ to ñ. The Normalizer class works as a lookup table, where the two Unicode values of n˜ are the lookup key to the table.

The Normalizer class handles the composition of two characters into one, however this may be used in repetition to assemble several characters into one, for example; multiple accent marks. The Normalizer class does not facilitate the composition of 2 or more characters into 2 or more different characters; these types of composition rules are handled by the Conjunctor class. It should be noted that, as in the case of the ArabicShaper, this operation may be reversed, turning n back into n and ˜.

Conjunctor (608)

A Conjunctor class is a generalized form of the Normalizer class. It facilitates very general rules of composition, as well as special case rules that appear frequently in some of the Indic languages, i.e. Hindi, Bengali, and Punjabi. Almost any rule can be handled by the Conjunctor class, while other classes, such as Normalizer or IndicParser, handle rules of a specific form in a much quicker fashion.

The Conjunctor class makes use of a lookup table of rules for each language it supports. These rules come from an external compiler that creates a compilable C++ code from a human readable file of rules. These rules can then be created for each language, and compiled into the various forms that are appropriate for inclusion in the database used by the engine of the present invention.

The Conjunctor class thus improves the way language rules are incorporated into the engine of the present invention. It allows the engine to evolve faster, and with less effort than prior text editing engines.

IndicParser (610)

An IndicParser class handles the complicated rules of composing in Indic languages. Many of the Indic languages have rules that govern the composition of characters into syllables. Some of these rules are of the form that is handled by the Conjunctor class, and the IndicParser class makes use of a Conjunctor class to carry out these compositions.

However, Indic languages contain many other rules including character reordering and syllable composition that cannot possibly all be handled efficiently by the Conjunctor class. These rules compose the responsibilities of the IndicParser class. While the IndicParser class works well enough on the general case to be applied to every Indic language, the rules with which the IndicParser class deals are far more specialized than the Conjunctor class, as they only appear in Indic languages.

CJKLookup (612)

A CJKLookup class facilitates the composition of Chinese, Japanese and Korean documents. This allows the use of tens of thousands of ideograms in each of these languages to be accessed by way of a limited number of keys on a typical computer keyboard.

The CJKLookup class further supports the PinYin alphabetization of Chinese, as well as the ZhuYin alphabetization. In Japanese, the Kana and Kanji alphabetization are supported. In Korean, the CJKLookup class makes use of the HangulParser, as discussed hereinbelow in greater detail. In Chinese and Japanese, the CJKLookup class utilizes a lookup table to output Chinese and Japanese characters from input strings.

HangulParser (614)

A HangulParser class parses Hangul input into Korean characters. The composition of Korean characters is completely algorithmic. While Korean contains thousands of ideograms, each ideogram can be composed of its constituent Hangul characters by a very simple, well-known algorithm. The simplicity of composing Korean characters allows Korean to be composed without making the use of a lookup table, thereby saving both space and time. The purpose of the HangulParser class is to compose Korean characters in this manner.

TextStorage (616)

Storage of the Unicode values that compose a document is handled by a TextStorage class. A TextStorage class is an object that is composed of a doubly linked list of medium sized arrays of pointers to CharElements. A CharElement is an array of one or more characters that compose a unit. These units are defined roughly by where a cursor can appear in editing text. For example, the cursor cannot appear between the “a” and the “´” of á. Many south-Asian languages have more complicated units.

This seemingly complicated manner of storing the characters of a document allows for the dynamic memory allocation and fast insertion of a linked list to be combined with the fast access of an array. Composing the text using character units makes cursor placement simple. It also provides a simpler method of composing and de-composing Indic type languages. For each composed unit of characters in the text storage, both the composed Unicode values and the original sequence that was typed are stored. This allows all the operations of the Normalizer, IndicParser, Conjunctor and ArabicShaper to be easily undone in order to prepare a document for viewing in a different editor.

MultilingualText (618)

A MultilingualText class builds on the TextStorage class to provide a cursor and cursor navigation to the TextStorage class. It is a class that is solely for cursor navigation, thus leaving any remaining responsibilities to the TextStorage class. For classes requiring access to text, but only for simple editing, the MultilingualText class provides a simple, small interface to the document text. More complicated editing such as parsing and contextualization requires access to the TextStorage interface.

GlyphImageHolder (620)

A GlyphImageHolder class is responsible for the storage and retrieval of raw bitmap data for each glyph. For every language, fonts are stored within a database so the editor does not have to depend on the fonts that come on the device. If the glyph data is stored in the database in a compressed, or outline format, the GlyphImageHolder class, and the classes that come below it, are responsible for converting the database format to a raw bitmap format. This process is discussed in greater detail during reference to the Reconstructor class set forth hereinbelow.

The GlyphImageHolder class contains several FontDataScript objects. A FontDataScript is similar to a GlyphImageHolder in its responsibilities, but each FontDataScript only holds a limited number of glyphs, for the most part, grouped into separate FontDataScript objects along lines that group languages with common alphabets together.

Database (622)

For every class that the engine makes use of, if that class contains large amounts of data, the storage of that data is handled by a Database class. Because some platforms have different ways of storing large amounts of data, the Database class is permitted to be changed into a format with which the given platform can make best use.

In a simplest form, the Database class is composed of arrays, where each array contains all the necessary information for each class, or instance of a class, that requires large amounts of data to be stored. The arrays are composed of words; 2 bytes. A word is at the same time, not too big and not too small.

Should the specific platform require some other, native type of storage for large amounts of data, the Database class has an interface that may be used to wrap the platform's native way of storing data. This wrapping of a native database type with an interface defined by the engine must be used several devices, including on a palm computer platform.

GlyphImage (624)

A GlyphImage class is an image of a single glyph that can be passed out of the engine to the platform code, to be drawn to the screen. In its most basic form, the GlyphImage class consists of only the width and height of the contained glyph image, as well as the raw bitmap data that composes the image. In addition, it may contain an offset at which to render the image (if required). It should be noted that the render offset is already taken into account when the engine calculates the image placement and returns the x, y screen location. Thus, the render offset of a GlyphImage class may almost never be used by the platform code, except in the specific case of highlighted text.

However, this basic form requires the bitmap to be drawn pixel-by-pixel. Since this is a slow process, a NativeImage optimization (discussed below) may be employed. With such process, the GlyphImage class can also contain a native image type which is equivalent in appearance to the raw bitmap, but is in a format that is faster on the target platform. On a MICROSOFT® WINDOWS® device, the GlyphImage class could contain the raw bitmap data, as well as a Cbitmap. On other devices, the NativeImage will be different.

Once the NativeImage optimization is implemented, the GlyphImage allows the user of the object to inquire if the NativeImage has been created from the raw data, and to get a pointer to the NativeImage for rendering. The GlyphImage also provides the following methods: GlyphImage::createNativeImage, and Glyphimage::destroyNativeImage. In most cases these calls are made by the engine, and are not required by the platform code. More information regarding the NativeImage optimization will be set forth later in the present description in greater detail.

Painter (626)

A Painter class is not necessarily responsible for painting glyphs to the screen. Instead, the Painter class undertakes the difficult task of finding the proper screen location of every glyph in the text. In many languages, characters are not placed in a manner as simple as that in English. Several languages are written in a right-to-left order, and may be combined in a single document with left-to-right languages.

Other languages have characters which appear below or above previous characters, or that cause a following character to be pulled underneath it. There can also be line-breaking rules in a language that differ from those in English. The Painter class handles such situations.

When an instance of the text editing application of the present invention is created, one must give the location and size of the window in which the text is to appear. Using this information, the Painter class calculates how each character should be placed on the screen and returns an x, y value of the final location of the glyph to the platform programmer.

Since the visual order that appears on the screen is often very different from the literary or logical order that the text is to be read, the duties of the Painter class are far from a trivial task. The order that the characters are to appear on the screen in mixed left-to-right, right-to-left documents is given in the Unicode standard.

As the logical and visual order of the glyphs may differ, a decision may be made as to whether to store the text in the screen order for quick rendering to the screen (but complicated navigation through the seemingly illogical order of the glyphs of the differing languages), or to store the glyphs in the logical order and use a time-consuming algorithm to locate the characters on the screen. In a preferred embodiment, the characters are stored in the logical order. This includes a performance reduction in rendering.

To overcome such performance reduction, another class, BidiHelper class, is created for the purpose of calculating the screen order from the logical order. As such, the Painter Class is upgraded to allow the characters to be painted quickly from the logical order of the TextStorage class.

With such class, each character can be located on the screen by building upon the location of the previous character in visual order, just like in English. Every character may thus be linked in location to the character preceding it on the screen so painting occurs in the visual order. Further, storing in the logical order becomes the preferred method.

It should be noted that such class may also create complications with the algorithm of selection and highlighting of text, and inhibiting the engine's ability to make the algorithm of selection in combined left-to-right, right-to-left documents transparent to the platform programmer. As an option, this has been corrected with the addition of the methods: getFastCharImage, and initFastPaint. Each makes use of the foregoing calculation of the glyph locations, and makes highlighting transparent to the platform programmer.

NativeImage Optimization

Returning to the NativeImage optimization, such allows a platform-dependent image type to be contained within the GlyphImage object that the engine uses to store the glyphs of the thousands of characters it supports. Because the engine is platform-independent, the glyph data would be disallowed from being stored in a platform-dependent manner. By doing this, the platform programmer would be prevented from using fast algorithms for drawing to the screen that may be supported by the platform operating system. By doing so, all images must be drawn in a pixel-by-pixel manner. This is the slowest of possible ways to draw an image, and can unacceptably damage the performance of the engine on some small, and slow, platforms. The optimization is aimed to prevent the pixel-by-pixel drawing from being a nessasary side effect of platform independence.

This optimization allows the type NativeImage to be defined in the file, Types.h, and a method, GlyphImage::createNativelmage, to be created by the platform programmer to convert a bitmap image to a NativeImage type. Doing this conversion in memory, and then painting with a NativeImage, improves the performance of the text editing application.

Once this method is defined, the engine may start saving NativeImages it has already created and used recently. This improves performance farther, as the first time an “a” is typed by the user, the NativeImage is created and used to paint the “a” to the screen. The second time an “a” is typed, the NativeImage is already created and stored in memory, so time is saved by not having to make the conversion a second and third time.

To save on space, there are a limited number of glyphs that can be stored in this way. A glyph may be dropped from the saved glyphs list in order to make room for another. After this has happened, if the letter is re-typed, the engine will once again perform the conversion, and the NativeImage restored to the stored list.

Some platforms require extra screen information to create a native image. A GraphicsData class, which the present function receives as an argument, can be defined by the platform programmer to give the method access to this extra information. The GraphicsData class can then be passed into the engine through a function, setGraphicsData. If this method is left empty, the engine may call it, but a NativeImage will not be created. The platform-dependent code should always call the function, Glyphimage::nativeCreated, before attempting to draw a NativeImage to ensure that the optimization is implemented and working.

When the GlyphImage::createNativeImage function is left empty, the platform code must paint pixel-by-pixel. Once the method is coded, the engine may call it and create NativeImages for every GlyphImage that the engine returns to the platform code. It should be noted that the platform programmer should not make use of GlyphImage::createNativeImage for images returned from the engine. Once the method is created, any GlyphImage returned from the engine has already had this method called or simply pulled the NativeImage from the stored table. Calling it again may damage performance.

When writing the code for Glyphimage::createNativeImage, a platform programmer may set a variable, ntvCreated, to true, and allocate a new NativeImage. The pointer, “ntv,” may be set to the new NativeImage, and then the conversion from raw bitmap to NativeImage type can be performed.

Failure to write the GlyphImage::createNativeImage method will not necessarily cause difficulties with the engine of the present invention, but may, on some platforms, result in slower performance. On most platforms, the overall improvement in performance due to the present invention is dramatic.

Reconstructor

As the engine of the present invention is used on low-memory devices, the large amounts of font data that allow the rendering of so many foreign characters may often be compressed. More information regarding such compression algorithms may be found with reference to co-pending applications entitled “SYSTEM, METHOD AND COMPUTER PROGRAM PRODUCT FOR A HIGHLY COMPRESSED OUTLINE FONT ENGINE” and filed under application Ser. No. 09/685,989 on Oct. 10, 2000; “SYSTEM, METHOD AND COMPUTER PROGRAM PRODUCT FOR LOSSLESS COMPRESSION FOR BITMAPS” filed under Ser. No. 09/686,439 on Oct. 10, 2000; “SYSTEM, METHOD AND COMPUTER PROGRAM PRODUCT FOR IMPROVED LOSSLESS COMPRESSION FOR BITMAP FONTS” filed under attorney docket number WOR1P003; and “SYSTEM, METHOD AND COMPUTER PROGRAM PRODUCT FOR GENERIC OUTLINE FONT COMPRESSION” filed under attorney docket number WOR1P004, which are each incorporated herein by reference in their entirety.

The Reconstructor is a group of classes to be selected among by the compression needs of the end user and platform. Every Reconstructor class is responsible for converting the compressed data of its given type into a raw bitmap of the desired size for each glyph that is painted to the screen. For non-compressed font data, the Reconstructor classes can be used for something as simple as scaling, but in practice each Reconstructor class performs a series of algorithms to create an accurate and aesthetically pleasing glyph.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for multi-lingual text editing on any one of a plurality of devices, comprising the steps of:
(a) identifying a device;
(b) programming a text editing application for the device, the programming including defining undefined variables of the text editing application and implementing a user interface in accordance with the identified device;
(c) loading the text editing application with data to support a plurality of languages; and
(d) selecting which of the languages are to be used with documents edited by the text editing application, wherein the selection is carried out on the device.

2. The method as recited in claim 1, wherein the device includes a personal digital assistant (PDA).

3. The method as recited in claim 1, wherein the device includes a palm computer.

4. The method as recited in claim 1, wherein the device includes a cellular phone.

5. The method as recited in claim 1, and further comprising the step of re-programming the text editing application for allowing the text editing application to edit text in additional selected languages.

6. The method as recited in claim 1, wherein the undefined variables are defined in accordance with a display on the identified device.

7. The method as recited in claim 6, wherein the text editing application writes text to a virtual display using computer code which is translated for allowing the text to be written to the display of the identified device.

8. The method as recited in claim 1, wherein the text editing application allows the edits of text in the selected languages by loading compressed font data, which is decompressed upon use.

9. The method as recited in claim 1, wherein the text editing application is capable of converting ASCII values on an English keyboard into Unicode values.

10. The method as recited in claim 1, wherein the text editing application is capable of contextualization of languages selected from the group consisting of Arabic, Urdu, and Farsi.

11. The method as recited in claim 1, wherein the text editing application follows rules of composition associated with Indic languages.

12. The method as recited in claim 11, wherein the text editing application combines two Unicode values into a single Unicode value per the rules.

13. The method as recited in claim 1, wherein the text editing application allows the use of a plurality of ideograms from languages selected from the group consisting of Chinese, Japanese, and Korean, by utilizing a look-up table.

14. The method as recited in claim 1, wherein the text editing application parses Hangul input into Korean characters.

15. The method as recited in claim 1, wherein the text editing application stores Unicode values utilizing a doubly linked list of arrays of pointers that point to one or more characters which compose a unit of a target language.

16. The method as recited in claim 1, wherein the text editing application stores raw bitmap data for a plurality of glyphs.

17. The method as recited in claim 1, wherein the text editing application outputs a width and a height of a glyph image and raw bitmap data that composes the glyph image.

18. The method as recited in claim 1, wherein the text editing application stores a plurality of glyphs in a predetermined logical order, and calculates a screen order from the logical or literary order.

19. The method as recited in claim 1, wherein the text editing application stores and uses device image types supported by the device.

20. The method as recited in claim 19, wherein the text editing application converts the device image types to application image types supported by the text editing application.

21. The method as recited in claim 20, wherein the text editing application buffers the application image types supported by the text editing application for reuse.

22. A computer program product for multi-lingual text editing on any one of a plurality of devices, comprising:
(a) a text editing application for being programmed by defining undefined variables of the text editing application and implementing a user interface in accordance with an identified device;
(b) computer code for loading the text editing application with data to support a plurality of languages; and
(c) computer code for selecting which of the languages are to be used with documents edited by the text editing application, wherein the selection is carried out on the device.

23. A system for multi-lingual text editing on any one of a plurality of devices, comprising:
(a) a text editing application for being programmed by defining undefined variables of the text editing application and implementing a user interface in accordance with an identified device;
(b) logic for loading the text editing application with data to support a plurality of languages; and
(c) logic for selecting which of the languages are to be used with documents edited by the text editing application, wherein the selection is carried out on the device.
